(19) United States
(12) Patent Application Publication
(10) Pub. No.: US 2025/0188970 A1
(43) Pub. Date: Jun. 12, 2025

(54) PERMANENT LOCKING MECHANISM FOR AN ADJUSTABLE SEALING SLEEVE

(71) Applicant: PIPETRONICS GMBH & CO KG, Stutensee (DE)

(72) Inventor: Markus LÄMMERHIRT, Stutensee (DE)

(21) Appl. No.: 18/842,315

(22) PCT Filed: Feb. 28, 2023
(86) PCT No.: PCT/EP2023/054975

§ 371 Date: Aug. 28, 2024

(30) Foreign Application Priority Data
Feb. 28, 2022 (DE) 10 2022 104 690.7

(51) Int. Cl. F16B 11/00; F16L 55/163

(52) U.S. Cl. CPC F16B 11/006; F16L 55/163

(57) ABSTRACT

The invention relates to a locking device for locking a set internal diameter of an adaptable sealing sleeve which is made of a belt that has two overlapping ends, comprising a housing (31) with a locking element (37) and a spring element (33). The locking element is movably arranged in a chamber (35) of the housing and is operatively connected to the spring element, and the locking device comprises an adhesive storage container (1) in which an adhesive is arranged that can be released in order to securely connect the locking element to the chamber and/or to the row of teeth by means of an adhesive so that the lock of the sealing sleeve is permanent.

The present invention relates to a locking device for locking the adjusted inner diameter of an adjustable sealing sleeve, which is formed from a band with two overlapping ends that are locked together by a locking mechanism to adjust the inner diameter.

Two basic types of pipeline system seals are known in the prior art. One type involves an internal seal, where a conventional rubber-armored sealing device is applied from the inside against the leak point on the inner wall of the pipeline system.

The second type involves an external seal applied from the outside against the leak point on the outer wall of the pipeline system.

For example, a conventional internal seal may consist of an internal sealing sleeve that includes an expandable elastic band, such as a steel band or a band made of a plastic-like material, and a locking device.

The steel band is expanded manually or with mechanical assistance when transitioning from the open to the locked position, and it is held in the expanded, or locked, position by the locking device.

For example, the internal end of the steel band may have a slot with one or two rows of teeth, while the external end of the steel band may have a tensioning gear rotatably mounted on it.

A tension spring causes the locking gear to engage with the rows of teeth in the slot, so that after expansion, the tension in the internal sealing sleeve is maintained by the locking gear engaging with the teeth in the slot, keeping the sleeve locked in its expanded state. The locking gear, under the influence of the tension spring, ensures that the tension in the internal sealing sleeve is maintained after expansion, and the external sealing band applied on the outside of the sleeve is pressed firmly against the leak point in the pipeline system.

However, it has been found that the locking mechanism of this conventional internal sealing sleeve is complex and prone to malfunction, as the locking gear must be rotatably mounted with a guide gear and a locking gear.

The tension spring acts on the rotational axis of the locking gear, keeping the locking gear engaged with the guide gear and pressing it into the space between the tensioning gear and the guide gear. The construction is not only complex and prone to failure but also does not guarantee a permanent seal of the leak point in the pipeline system due to the vulnerability of the mechanism to material fatigue.

For example, DE 20 2016 104 723 U1 describes a conventional sealing sleeve for internal installation in a pipeline system to seal the leak point on the inner wall of the pipeline system. This sleeve comprises a ring-shaped, expandable steel band with two band ends, where the internal end overlaps with the external end in an overlapping area.

The conventional sealing sleeve also includes a locking device, which consists of a slot arranged circumferentially in the steel band with at least one row of teeth and a locking element. The locking element engages with its teeth in the row of teeth in the slot. The locking element has a carrier equipped with several elastic plastic-like spring elements, which are elastically spring-loaded and pivotable against the carrier.

The spring elements are securely connected to the plastic-like carrier, possibly in one piece, and are oriented obliquely to the circumferential direction, with the distance between the free ends of adjacent spring elements corresponding to the distance between adjacent teeth in the rows of teeth in which the free ends of the spring elements engage.

In this conventional sealing sleeve, the locking device proves to be sensitive to the high pressure forces that can act on the spring elements, so that a permanent expansion or spreading of the sealing sleeve with the sleeve remaining in the locked position and the external sealing band being pressed against the leak point is not durable. Due to material fatigue, the spring elements made of plastic-like material fail to remain engaged in the rows of teeth in the slot. The material fatigue leads to cracks and splits in the spring elements, causing them to crumble and the sealing sleeve to return to its open position, thus exposing the leak point.

DE 10 2020 122 833 B3 describes an internal sealing sleeve for insertion into pipes. The disclosed sealing sleeve is specifically a liner end sleeve. The internal sealing sleeve has a sleeve body made of a ring-shaped bent band, where the inner end and the outer end overlap.

The sleeve body is expandable so that the inner band end is displaceable relative to the outer band end along an expansion direction. A locking arrangement prevents the inner band end from being displaced back relative to the outer band end against the expansion direction.

The locking arrangement includes a slot arranged circumferentially at the inner band end with a row of teeth and a locking mechanism with a locking element. The locking element is under the influence of a spring element and engages with its locking teeth in the row of teeth. The locking element and the spring element are arranged in a chamber of a guide body, with the locking element being displaceable within the chamber.

A problem with all adjustable sealing sleeves is that the locking device used can become disengaged after setting the desired inner diameter. This is undesirable but can occur over long periods (months, years) due to material fatigue, vibrations, etc.

In unfavorable circumstances, the locking device may fail even within significantly shorter periods. This cannot be prevented by the solutions in the prior art, even if it is intended that the sleeve only expands and does not reduce in diameter again.

Therefore, the objective of the present invention was to overcome the disadvantages of the prior art and, in particular, to provide a device that permanently fixes the once-adjusted inner diameter of an adjustable sealing sleeve.

This objective is achieved by a locking device for locking the adjusted inner diameter of an adjustable sealing sleeve, which is formed from a band with two overlapping ends, comprising a housing with a locking element and a spring element, where the locking element is movably arranged in a chamber of the housing and interacts with the spring element, and where the locking element engages in a row of teeth arranged on the band through an opening in the chamber to lock the band in a direction of movement, and where an adhesive reservoir is provided, containing an adhesive that can be released to permanently bond the locking element to the chamber and/or the row of teeth, making the sealing sleeve's locking permanent.

The inner diameter of a sealing sleeve refers to the diameter of the cavity inside the sealing sleeve. The inner diameter plus the thickness of the sealing sleeve corresponds to the diameter of the pipe to be sealed.

A tooth row according to the invention is particularly formed in a sawtooth profile, with the edges perpendicular to the opening being arranged in the direction of movement of the locking device when locking.

It can be provided that the row of teeth is particularly arranged vertically to the direction of movement of the band ends relative to each other, with the housing particularly resting on or formed in the band end.

According to one embodiment, it can be provided that the locking element has another row of teeth corresponding to the row of teeth on the band.

The additional row of teeth on the locking element is particularly formed in a sawtooth profile, with the edges perpendicular to the opening being arranged against the direction of movement of the locking device when locking, so that in a locked state, these lie on the perpendicular edges of the row of teeth in the opening.

The present invention is based on the surprising finding that an additional locking of a sealing sleeve can be achieved when the locking mechanism is partially or completely glued and thus additionally fixed.

This can be achieved according to the invention by providing an adhesive reservoir that, under the influence of mechanical pressure forces, releases the stored adhesive either into the chamber, where the spring and part of the locking element are arranged, and/or in the area of the row of teeth and the locking element engaged there, and the adhesive cures there. In the cured state, the movable parts of the device are fixed, and the sleeve's diameter can no longer be altered.

For example, when a sealing sleeve is inserted into a pipe and expanded, the sleeve body is designed to be expandable so that the inner band end is movable relative to the outer band end along an expansion direction, as described. The locking arrangement prevents the inner band end from being displaced back relative to the outer band end against the expansion direction.

The sealing sleeve is expanded until it rests against the inner wall of the pipe and should be permanently locked in this shape. The locking element and the additional bonding of the locking element with the spring element in the chamber and/or with the row of teeth serve this purpose.

According to one embodiment of the present invention, it can be preferred that the adhesive reservoir is arranged on the outer side of the housing of the locking element facing the inside of the sealing sleeve, and that the adhesive reservoir has a closure that opens when a predetermined opening pressure is exceeded, allowing the adhesive stored in the adhesive reservoir to flow into the chamber and/or enclose the locking element and the row of teeth.

If, according to the embodiment, the sealing sleeve is pressed against the inner wall of the pipe, pressure is applied to the adhesive reservoir, as it is located on the outer side of the sealing sleeve and the inner side of the pipe. At the moment when the sealing sleeve has reached the desired expanded diameter, the adhesive is pressed out of the adhesive reservoir and permanently fixes the locking mechanism.

A particular advantage of the present invention is that no manual operation is required. The cuff automatically locks into place at the desired point through the adhesive reservoir, completely independent of user error.

It can be particularly provided that the adhesive is a 2-component adhesive, made using methyl methacrylate compounds, which may have a boiling point higher than 100° C. or 150° C., a flash point of 11° C. or 20° C., a vapor pressure of 157 mbar, a density of 1.07 g/cm³ or 0.95 g/cm³, and/or low solubility in water at 20° C. Preferably, the adhesive has a viscosity of 60,000 mPas to 80,000 mPas, more advantageously 70,000 mPas at 20° C.

Such 2-component adhesives have the particular advantage of being stored separately in the adhesive reservoir of the invention and only being mixed when pressed out of the reservoir by mechanical pressure. After mixing, the two components can be selected to cure quickly, as the adhesive reservoir is preferably located at or near the chamber and/or the locking element.

It may be preferred that the opening pressure to release the adhesive is at least 0.1N, preferably at least 1N, particularly preferably 5N, and most preferably a maximum of 100,000N, and/or at least 0.1 bar, preferably at least 0.5 bar.

The desired opening pressure for releasing the adhesive can be chosen almost freely. It has proven advantageous if this pressure is not too low to avoid accidental triggering.

It is particularly advantageous, as described, if the opening pressure to open the closure is provided by moving the band when adjusting the inner diameter or by applying pressure from inside the sealing cuff to the outside of the adhesive reservoir, particularly if the adhesive reservoir is made from an elastic material.

The choice of material for the adhesive reservoir depends on the desired pressure required to release the adhesive. Furthermore, the geometry and wall thickness are selected accordingly. The selection of suitable materials and geometries is up to the expert, with examples of adhesive container designs available in the literature depending on the application.

According to a particularly preferred embodiment, the adhesive reservoir has two chambers separated by a partition wall, with one component of a 2-component adhesive stored in each chamber. Both chambers are connected to the closure and, under opening pressure, the adhesive components flow from the two chambers through the closure and mix.

Pot life of adhesives can be problematic with a device according to the invention. This is avoided by using multi-component adhesives, particularly 2-component adhesives. With such adhesives, selecting the appropriate viscosity is important to ensure the adhesive flows securely to the desired areas and remains there.

It may prove advantageous if the adhesive has a viscosity range at 20° C. of between 20,000 mPas and 1,000,000 mPas, preferably between 40,000 mPas and 800,000 mPas, or between 50,000 mPas and 500,000 mPas, and more preferably between 60,000 mPas and 600,000 mPas, for reliable bonding of the locking element.

Further advantageous embodiments of the chamber are described below.

The chamber opening preferably has the same length as the row of teeth of the locking element. The invention may provide that the row of teeth is arranged on an outer band end and the locking device on an inner band end on a curved band forming the cuff body, with the inner and outer band ends overlapping.

In particular, it is provided that the cuff body formed from the band is present in a transport state as a band or as an expandable cuff, where the cuff is formed by overlapping the inner band end with the outer band end and inserting the locking device into the recess.

The invention may provide that the locking device includes a second locking element and the recess includes a second row of teeth opposite the first, with the second locking element movably arranged in the chamber of the housing and operatively connected to the first spring element, engaging the second row of teeth through a second chamber opening.

In a preferred embodiment, a second locking element and a second row of teeth in the recess are provided. This has the particular advantage that the sealing cuff, after locking, is evenly loaded and the tension force of the cuff is distributed over two rows of teeth, leading to increased durability and lifespan.

The second chamber opening preferably has the same length as the row of teeth of the second locking element.

The first and second locking elements are particularly connected to the same spring element and are pressed by it towards the first and second openings.

The invention may provide that the housing chamber has a first and second part, with the first part designed and arranged to accommodate the first locking element and first spring element, and the second part designed and arranged to accommodate the second locking element and a second spring element, while having a second chamber opening.

In particular, a mirror-image arrangement of the first and second parts of the chamber with the respective first and second locking elements and spring elements is provided. This ensures that the forces acting through the cuff are evenly distributed.

The invention may provide that the first locking element is connected to the first spring element and the second locking element to the first or second spring element, with the first and/or second spring element connected to the housing.

In a preferred embodiment, such a connection may be provided to prevent the locking element and/or spring element from falling out.

The invention may provide that the first and/or second spring element is shaped as coil springs, leaf springs, flat springs, leaf springs, spring clips, spiral springs, disc springs, wave springs, conical springs, barrel springs, or ring springs.

The spring elements are particularly made of corrosion-resistant materials, such as stainless steel and/or plastic, and are suitable for use in drinking water.

It can also be provided that the spring element is a body made of elastic material that exhibits a spring effect.

The invention may provide that the first and/or second spring element includes a locking device designed and arranged to maintain the restoring force of the spring element and release it when needed. In a preferred embodiment, the first and/or second locking element does not engage the first and/or second row of teeth of the recess when in the locked state.

This has the particular advantage that the locking device can be more easily inserted into the recess when in a locked state.

The invention further provides for the use of a locking device to determine the inner diameter of an adjustable sealing cuff.

Further features and advantages of the invention will become apparent from the following description, in which exemplary embodiments of the invention are explained with reference to schematic drawings, without limiting the invention.

These show:

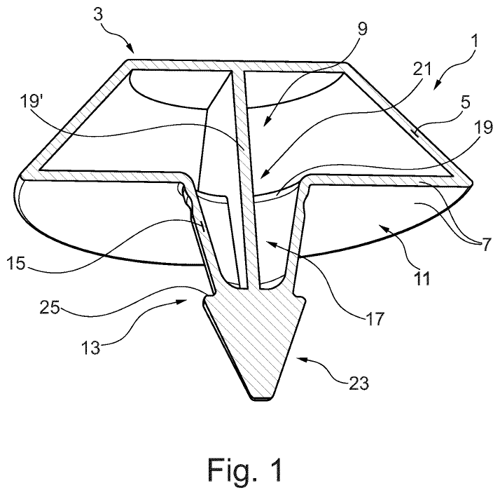

FIG. 1: a schematic sectional view of an adhesive reservoir according to the invention for a locking device for determining the inner diameter of an adjustable sealing cuff;

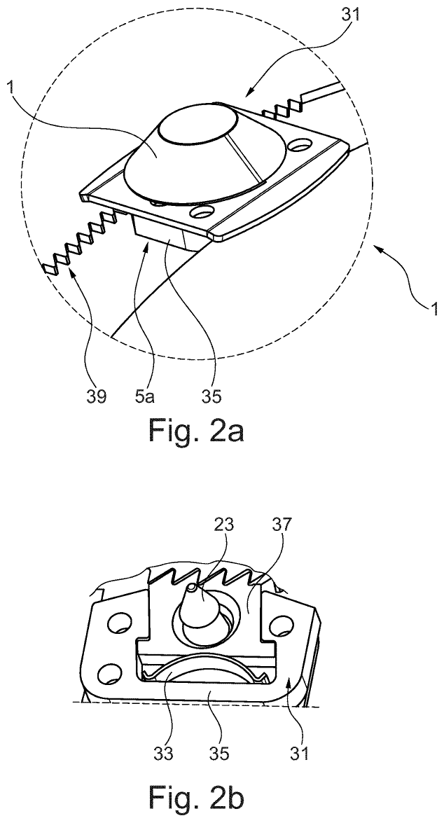

FIGS. 2a and 2b: schematic views of a locking device according to the invention from the “inside” and “outside” of a sealing cuff; and

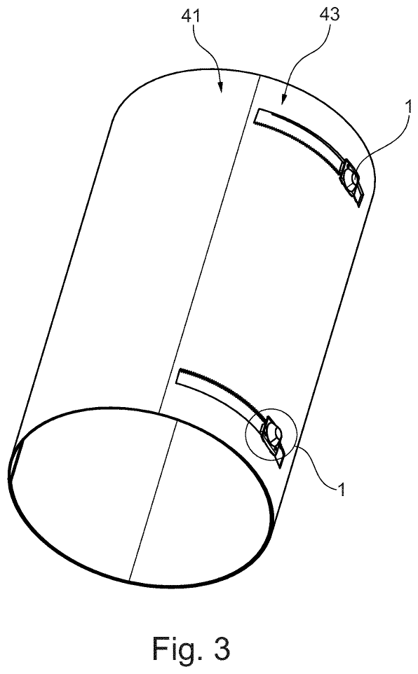

FIG. 3: a schematic, perspective view of a locking device according to the invention on a sealing cuff.

In FIG. 1, a schematic sectional view of an adhesive reservoir 1 according to the invention in an exemplary embodiment is shown.

The adhesive reservoir 1 shown comprises an outer container 3 with an inner space 9 laterally bounded by a side wall 5, preferably conically tapering in longitudinal section, and at the bottom by a base 7. On the underside 11 of the base 7, opposite the side wall 5, a pointed cap 13 is formed, having another conically shaped interior space 17 bounded by a cap wall 15, conically tapering in longitudinal section, which is divided into two subspaces by a film 19′ for the reception of 2-component adhesive. The further inner space 17 is separated from the inner space 9 of the outer container by a film 19 via an opening 21. A tip 23 of the cap 13, facing away from the side wall 5, is formed with an outwardly protruding abutment surface 25 to abut against a part of a chamber of the locking device, with the underside 11 of the base 7 of the outer container 3 abutting against this part of the chamber.

The embodiment shown in FIG. 1 is to be understood as purely exemplary. It has proven advantageous according to the invention if an adhesive reservoir 1 has two chambers to store the two components of a 2-component adhesive separately. Since the adhesive reservoir 1 is preferably made of a flexible material to release the adhesive through external deformation, it is preferably provided according to the invention to also use a deformable film 19, 19′ to separate the two inner spaces.

The cap 13 is one possible embodiment, as its removal can occur either through the internal pressure in the adhesive reservoir 1 generated by pressing the sealing cuff against an inner wall of a pipe during expansion or by stripping the cap 13 when moving the two overlapping ends of the band forming the sealing cuff. Other designs are, of course, conceivable and encompassed by the invention, such as designs with perforating films under pressure, variants with (forced) mixers for the 2-component adhesives, etc.

As shown in FIGS. 2a and 2b below, the adhesive reservoir 1 can be positioned on the outside of a locking device 31, which is in turn placed on a sealing sleeve (not shown).

An embodiment of an adjustable sealing sleeve is formed from a band that has two overlapping ends. At this end (not shown), the housing 31 is equipped with a locking element 37 and a spring element 33, with the locking element 37 being movably arranged in a chamber 35 of the housing 31 and in operative connection with the spring element 33.

To lock the two band ends together, the locking element 37 engages with a row of teeth 39 arranged on the band through an opening in the chamber 35 to lock the band in one direction of movement.

The adhesive reservoir 1 is positioned, as shown in FIGS. 2a and 2b, on the outside of the housing 31 of the locking element 37, facing the inside of the sealing sleeve.

When a predetermined opening pressure is exceeded, the closure, in the form of an exemplary cap 13, opens, allowing the adhesive stored in the adhesive reservoir 1 to flow into the chamber 35, surrounding the locking element 37 and the row of teeth 39.

As clearly shown in FIG. 3, the opening pressure can be applied by expanding a sleeve according to the invention against the inner wall of a pipe. Once the sleeve presses against the inner wall during expansion, a corresponding pressure is exerted on the adhesive reservoir 1, releasing the adhesive stored inside, which permanently secures the locking device according to the invention.

It may be provided that two locking devices according to the invention, each with an adhesive reservoir 1, are used, positioned at both ends of the sealing sleeve.

The features of the invention disclosed in the foregoing description and the claims may be essential to the implementation of the invention in its various embodiments, either individually or in any combination.

1. Locking device for locking a set inner diameter of an adjustable sealing cuff, formed from a band with two overlapping ends, comprising a housing with a locking element and a spring element, wherein:
the locking element is movably arranged in a chamber of the housing and is operatively connected to the spring element, and wherein:
the locking element engages a row of teeth arranged on the band through an opening in the chamber to lock the band in one direction of movement,
characterized in that:
an adhesive reservoir is included, containing an adhesive that can be released to permanently bond the locking element to the chamber and/or to the row of teeth using the adhesive, thereby permanently securing the sealing cuff.

2. Device according to claim 1, characterized in that:
the adhesive reservoir is arranged on the outer side of the housing of the locking element facing the interior of the sealing cuff, and wherein the adhesive reservoir has a closure that opens when a predetermined opening pressure is exceeded, allowing the adhesive stored in the adhesive reservoir to flow into the chamber and/or surround the locking element and row of teeth.

3. Device according to claim 1, characterized in that:
the opening pressure for releasing the adhesive is at least 0.1N, preferably at least 1N, particularly preferably 5N, and most preferably a maximum of 100,000N, and/or at least 0.1 bar, preferably at least 0.5 bar.

4. Device according to claim 1, characterized in that:
the opening pressure for opening the closure is provided by moving the band when adjusting the inner diameter or by applying pressure from the inside of the sealing cuff to the outer side of the adhesive reservoir, wherein the adhesive reservoir is particularly made from an elastic material.

5. Device according to claim 4, characterized in that:
the adhesive reservoir comprises two chambers separated by a partition wall, with each chamber containing a component of a 2-component adhesive, wherein both chambers are operatively connected to the closure, and the adhesive components flow from the two chambers through the closure and mix under the opening pressure.

6. Device according to claim 1, characterized in that:
the opening pressure is provided by pressing the cuff against an inner wall of a channel, particularly by expanding the sealing cuff.

7. Device according to claim 1, characterized in that:
the adhesive has a viscosity range at 20° C. between 20,000 mPas and 1,000,000 mPas, preferably between 40,000 mPas and 800,000 mPas, or between 50,000 mPas and 500,000 mPas, and more preferably between 60,000 mPas and 600,000 mPas, for reliable bonding of the locking element.

8. Locking device according to claim 1, characterized in that:
the chamber of the housing has a first and a second part, wherein the first part is designed and arranged to accommodate the first locking element and the first spring element, and the second part is designed and arranged to accommodate the second locking element and a second spring element, while having a second opening in the chamber, wherein an adhesive reservoir is provided for both locking elements, or a separate adhesive reservoir is provided for each locking element.

9. Locking device according to claim 8, characterized in that:
the first locking element is connected to the first spring element and the second locking element is connected to the first spring element or the second spring element, and the first and/or second spring element is connected to the housing.

10. Use of a locking device according to claim 1 to fix an inner diameter of an adjustable sealing cuff.

11. Use according to claim 10 in pipeline rehabilitation.
